(19) United States
(12) Patent Application Publication
(10) Pub. No.: US 2026/0259726 A1
(43) Pub. Date: Sep. 3, 2026

(54) SERVER, ELECTRONIC COMPONENT OF A DATA PROCESSING SYSTEM AND METHOD FOR PUTTING THE ELECTRONIC COMPONENT INTO OPERATION

(71) Applicant: WAGO Verwaltungsgesellschaft mbH, Minden (DE)

(72) Inventors: Andre BELL, Minden (DE); Jonathan JANSEN, Porta Westfalica (DE)

(73) Assignee: WAGO Verwaltungsgesellschaft mbH, Minden (DE)

(21) Appl. No.: 19/554,593

(22) Filed: Mar. 2, 2026

(30) Foreign Application Priority Data
Mar. 3, 2025 (DE) 10 2025 108 029.1

(51) Int. Cl. G06F 8/65

(52) U.S. Cl. CPC G06F 8/65

(57) ABSTRACT

Provided is a server, an electronic component of a data processing system, and a method for putting the electronic component of the data processing system into operation. The method comprises storing a link between a unique identifier of the electronic component and an operational firmware version in a database, receiving, by the server, a request from the electronic component, wherein the request comprises the unique identifier, determining, by the server, the operational firmware version based on the link stored in the database, and transferring, by the server, one or more update files associated with the operational firmware version to the electronic component.

This nonprovisional application claims priority under 35 U.S.C. § 119(a) to German Patent Application No. 10 2025 108 029.1, which was filed in Germany on March 3, 2025, and which is herein incorporated by reference.

### BACKGROUND OF THE INVENTION

### Field of the Invention

The present invention relates to a server, an electronic component of a data processing system and a method for putting the electronic component into operation.

### Description of the Background Art

When an electronic component is delivered by a manufacturer, it may comprise software that is no longer up-to-date at the time of putting the electronic component into operation by the user, or which does not fully meet the user's requirements for other reasons, e.g., because the software provided by the manufacturer is not adapted to the environment in which it is to operate. When putting an electronic component into operation, it may therefore be necessary or advantageous to replace or supplement the software with which the electronic component was delivered, so that after putting the electronic component into operation, the electronic component is equipped with software which differs in terms of up-to-datedness and/or functionality from the software with which the electronic component was delivered by the manufacturer.

In this regard, EP3596595A1 proposes to design a computing device in such a way that, upon first startup, it automatically registers its serial number with a server, which then provides the computing device with an address from which the computing device can download a management agent. Once installed on the computing device, this agent enforces compliance with certain policies when using the computing device.

### SUMMARY OF THE INVENTION

The method for putting the electronic component into operation may comprise storing a link between a unique identifier of the electronic component and an operational firmware version in a database, receiving, by the server, a request from the electronic component, wherein the request comprises the unique identifier, determining, by the server, the operational firmware version based on the link stored in the database, and transferring, by the server, one or more update files associated with the operational firmware version to the electronic component. Furthermore, the database can be provided on a non-transitory computer readable medium.

In this regard, the term "putting into operation", may refer to putting an electronic component, provided by the manufacturer with a generic basic functionality, into an operational state by making user-specific or application environment-specific changes and/or adjustments. The user-specific or application environment-specific changes and/or adjustments may comprise, for example, updating, replacing, and/or adding software packages. In particular, putting into operation may comprise replacing a generic firmware installed by the manufacturer with an application-environment-specific (user-defined) firmware. The application-environment-specific (user-defined) firmware may, for example, support the interaction of the electronic component with other electronic components and thereby simplify the composition of a system from said electronic components.

Furthermore, the term “electronic component of a data processing system”, may refer to an electronic device which comprises a processor and a memory (in which firmware in the form of instructions executable by the processor may be stored, for example stored on a non-transitory computer readable medium). Furthermore, the term “electronic component of an automation system”, may refer to an electronic device which comprises a processor and a memory (in which firmware in the form of instructions executable by the processor may be stored) and is configured for connecting to, or establishing a connection with, field devices (e.g., sensors and/or actuators). The electronic component may be, for example, a base module (head station) or an expansion module (I/O module) of a modular fieldbus node.

In this context, the term “head station”, may refer to a component of a modular fieldbus node whose task it is to make the data and/or services of the I/O modules, which are connected to the head station, available via the fieldbus to which the head station is connected. In this regard, the term “I/O module”, may refer to an electronic component which is serially connectible, or (during operation) serially connected, to a head station and which connects one or more field devices with the head station and, if necessary (via the head station) with a higher-level control unit.

An I/O module may have one or more inputs and/or outputs for connecting field devices with the I/O module. Before a field device can be connected to an I/O module, it may be necessary or advantageous to supply the I/O module with a specific firmware version and to configure the I/O module to operate the field device. For example, it may be necessary or advantageous that all I/O modules of a modular fieldbus node are supplied with the same firmware version or at least compatible firmware versions. Furthermore, the ability to configure an I/O module to operate in a specific operating environment (as desired or required) may depend on the firmware version with which the I/O module is supplied.

As part of the configuring, it may, for example, be specified which data is to be derived from signals received through the inputs of the I/O module and transmitted to the head station. Furthermore, it may be specified as part of the configuring which signals are to be derived from data received from the head station and output through the outputs of the I/O module. Furthermore, it may be specified as part of the configuring how the head station is to communicate with the I/O modules. In addition, a change or update of a configuration data set stored in the I/O module may be necessary after an initial configuration if, for example, the assigned tasks and/or the environment of an I/O module changes, or a defective I/O module needs to be replaced.

When a head station is put into operation or an (additional) I/O module is added to the head station, it may also be necessary or advantageous to provide the head station with a specific firmware version and then configure the head station (for the operation of the I/O module). For example, it may be necessary or advantageous that the head station and the I/O modules of a modular fieldbus node are supplied with the same firmware version or at least compatible firmware versions. Furthermore, the ability to configure the head station to operate in a specific operating environment (as desired or required) may depend on the firmware version with which the head station is supplied.

By configuring the head station, it may, for example, be specified how the head station is to communicate with a higher-level control unit and whether (or which) data of the I/O module is to be processed by the head station or forwarded to the higher-level control unit. Furthermore, configuring the head station may specify whether (or which) data from the higher-level control unit is to be processed by the head station or forwarded to one or more I/O modules. Moreover, it may be specified as part of the configuring how an I/O module can/should communicate with the head station and, if applicable, with other I/O modules. In addition, a change or update of a configuration data set stored in a head station may be necessary after an initial configuration if, for example, the assigned tasks and/or the environment of a head station changes, or a defective head station needs to be replaced.

The term "configuration data set", may refer to a data set that specifies how process images are to be generated (e.g., how data is to be derived from signals received through the inputs of the I/O module and how said data is to be transmitted, e.g. via a bus, to the head station or from the head station to the higher-level control unit) and/or which data is to be forwarded from the higher-level control unit to the I/O module or how signals are to be derived from data transmitted from the head station to the I/O module (which are output, e.g., through the outputs of the I/O module).

There may be field devices that provide state signals or process control signals connected to the inputs and/or outputs. In this regard, the term “field devices”, may refer to sensors and/or actuators which are connected (in terms of signaling) to the I/O module (e.g., electrically connected to the I/O module). Furthermore, the terms “input” and “output” may refer to electric terminals such as, for example, (electrically conductive) connecting clamps.

Moreover, the term “unique identifier” may refer to a (unique) serial number/device number.

The method may also comprise transferring the unique identifier and a basic firmware version to the electronic component. This may be performed, for example, by the manufacturer of the electronic component (before the sale or delivery of the electronic component) and without the knowledge of the user of the electronic component, so that the basic firmware version naturally has no application-environment-specific (user-defined) functionality.

The basic firmware version may have a smaller range of functions than the operational firmware version. For example, the basic firmware version may essentially be limited to establishing a connection to the server and installing one or more update files. The operational firmware version may, for example, facilitate the integration of the electronic component into a network by enabling the operation of certain inputs/outputs of the electronic component.

Furthermore, the term "server", may refer to a unit reachable via a network address (e.g. an IP address or an Internet address), which may be configured to receive the request of the electronic component, determine from a database an operational firmware version linked to the unique identifier of the electronic component and to transfer one or more update files associated with the operational firmware version to the electronic component.

The one or more update files associated with the operational firmware version may comprise one or more software modules, the addition of which transforms the basic firmware version into the operational firmware version.

The process may further comprise detecting, by a computing device (e.g. a mobile device such as a mobile phone, tablet, laptop, smart glasses, etc.), the unique identifier by near field communication (NFC), radio frequency identification (RFID), or an optical sensor. The unique identifier may, for example, be stored in a circuit or provided on a surface of the electronic component. In particular, the unique identifier may comprise information encoded in a one- or two-dimensional barcode affixed to the surface of the electronic component. The information contained in the one- or two-dimensional barcode may include, for example, a unique serial number/device number.

The information contained in the one- or two-dimensional barcode may further, or alternatively, include a device type, manufacturer identifier, model number, etc., which describe the electronic component. The information contained in the one- or two-dimensional barcode may further, or alternatively, include a network address (e.g., an IP address or an internet address) of the server. The information contained in the one- or two-dimensional barcode may further, or alternatively, include information by which the computing device can log in to the server.

Said information, and in particular the unique identifier, may be provided to the computing device by the electronic component through sequentially displaying code elements from which the information, e.g., the unique identifier, may be derived. For example, the code elements may be displayed sequentially on a digital display of the electronic component or by activating/deactivating one or more signal lights of the electronic component. For example, the sequential displaying of the elements may be performed by flashing one or more signal lights. In particular, the server may transmit login information to the electronic component, which the electronic component may transmit (optically) to the computing device and with which the computing device can log in to the server.

The computing device may further be configured to allow a (graphically supported) selection of the operational firmware version with which the electronic component is to be supplied and to transmit the information regarding the selected operational firmware version together with the unique identifier to the server. As part of the transmission, it may be necessary for the computing device to authenticate itself to the server. For example, the computing device may be configured to log in to the server with a username and a password. Depending on the result of the authentication, the server may receive the link between the unique identifier of the electronic component and an operational firmware version from the computing device and store it in a database.

The server may be configured to receive a request from an electronic component of a data processing system, in particular an automation system, which comprises a unique identifier of the electronic component, read an operational firmware version associated with the unique identifier of the electronic component from a database, communicate the operational firmware version associated with the unique identification of the electronic component to the electronic component, and/or to transfer one or more update files associated with the operational firmware version to the electronic component.

The basic firmware version may have a smaller range of functions than the operational firmware version and may, preferably, (essentially) be limited to establishing a connection to the server and installing the one or more update files.

The one or more update files associated with the operational firmware version may comprise one or more software modules, the addition of which transforms the basic firmware version into the operational firmware version.

The server may be further configured to transmit information to the electronic component by means of which a computing device can identify itself to the server as authorized to link the unique identifier of the electronic component with the operational firmware version.

The electronic component may display said information (possibly together with the unique identifier) automatically after an initial startup or at the request of an operator (e.g., a commissioning engineer), and the computing device may read said information by means of an optical sensor and use it to identify itself (possibly as part of a login to the server) as authorized to link the unique identifier of the electronic component with a specific operational firmware version.

The electronic component of a data processing system, in particular an automation system, may comprise a processor and a non-volatile memory, wherein a basic firmware version may be stored on the non-volatile memory, which may be configured to establish a connection to a server upon putting the electronic component into operation, send a unique identifier of the electronic component to the server, and receive one or more update files from the server.

The basic firmware version may have a smaller range of functions than the operational firmware version and may, preferably, (essentially) be limited to establishing a connection to the server and installing the one or more update files.

The one or more update files may comprise one or more software modules, the addition of which may transform the basic firmware version into the operational firmware version.

The electronic component may be configured to send a message containing the identifier over the network to the server as soon as the electronic component has established a data connection or in response to an input from an operator (e.g., a commissioning engineer). The input may include, for example, the actuation of a switch/button of the electronic component or a touch-sensitive display of the electronic component.

Furthermore, it is noted that all features described in connection with the server or the electronic component may also be features of the method and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a fieldbus system;

FIG. 2 shows a fieldbus node and field devices connected to the fieldbus node;

FIG. 3 shows a schematic representation of entities involved in the configuration of the fieldbus node;

FIG. 4 shows a schematic representation of entities involved in the configuration of the fieldbus node;

FIG. 5 shows a schematic representation of the communication between the entities shown in FIG. 4 when putting the fieldbus node into operation; and

FIG. 6 shows a flowchart of a method for putting an electronic component of a data processing system into operation.

### DETAILED DESCRIPTION

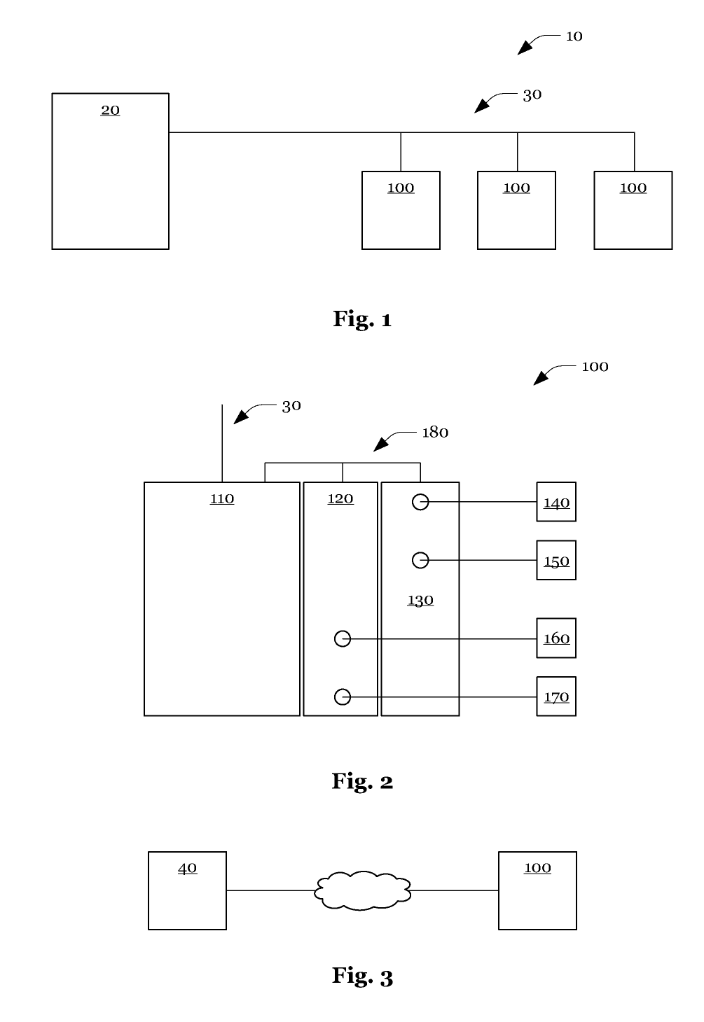

FIG. 1 shows a block diagram of a fieldbus system 10, which may be part of an automation system. The fieldbus system 10 may comprise a higher-level control unit 20, which may be connected to a large number of fieldbus nodes 100 via a fieldbus 30. The higher-level control unit 20 may be used both, for monitoring and for controlling, an installation (not shown) that is controlled by the fieldbus system 10. If the higher-level control unit 20 monitors an installation, the higher-level control unit 20 may cyclically or acyclically receive process data (e.g., state data) describing the state of the installation from the fieldbus nodes 100 and generate an alarm signal if the state of the installation deviates (substantially) from a desired/permitted state or state range. If the higher-level control unit 20 (not only monitors but also) controls the installation, the higher-level control unit 20 may cyclically or acyclically receive process data from the fieldbus nodes 100 and, taking the process data into account, determine control data that is sent to the fieldbus nodes 100.

FIG. 2 shows an exemplary modular fieldbus node 100, comprising a head module 110 and two I/O modules 120 and 130 which are serially connected to the head module 110. FIG. 2 further shows field devices 140, 150, 160 and 170, such as sensors and actuators, which are connected to the I/O modules 120 and 130. Which field devices can be connected to the I/O modules 120 and 130 may depend on the operational firmware versions of the I/O modules 120 and 130. During operation, the I/O modules 120 and 130 may read sensor signals through the inputs and generate process data from the sensor signals, which may be sent to the head station 110 via the local bus 180. The head station 110 may process the process data locally and/or may forward it (potentially in modified form) to the higher-level control unit 20. The higher-level control unit 20 (or head station 110 in the case of local processing) may then generate, taking the process data into account, control data.

The control data generated by the higher-level control unit 20 may then be transmitted to the (same or another) head station 110 via the field bus 30. The control data transmitted to the head station 110 (or generated by the head station 110) may then be forwarded/transmitted (potentially in modified form) to the I/O modules 120 and 130. The I/O modules 120 and 130 may receive the control data and output control signals corresponding to the control data at the outputs to which the actuators are connected. The communication of data between the components of the fieldbus system 10 and the mapping of sensor signals to process data and the mapping of control data to control signals may depend on the firmware version with which the head station 110 and the I/O modules 120 and 130 are equipped, and may be adapted to different environments or application scenarios by configuring the fieldbus nodes 100.

In this regard, FIG. 3a shows a fieldbus node 100 and a computing device 40 which may be configured to initiate the configuring of the fieldbus node 100, i.e., the head station 110 and/or the I/O modules 120 and 130 of the fieldbus node 100. The computing device 40 may comprise a display device on which a graphical interface of a configuration program may be shown. The graphical interface may allow graphically displaying the desired topology of the fieldbus node 100 and assigning the parameters required for configuration of the head station 110 and/or the I/O modules 120 and 130 (and in particular their inputs and/or outputs) or retrieving an assignment created on another computing device and stored on the computing device 40. A configuration data set for the head station 110 and each of the I/O modules 120 and 130 (or for all of them together) may then be formed from the parameters and transferred to and stored in the head station 110 and the I/O modules 120 and 130 of the fieldbus node 100 in order to configure them.

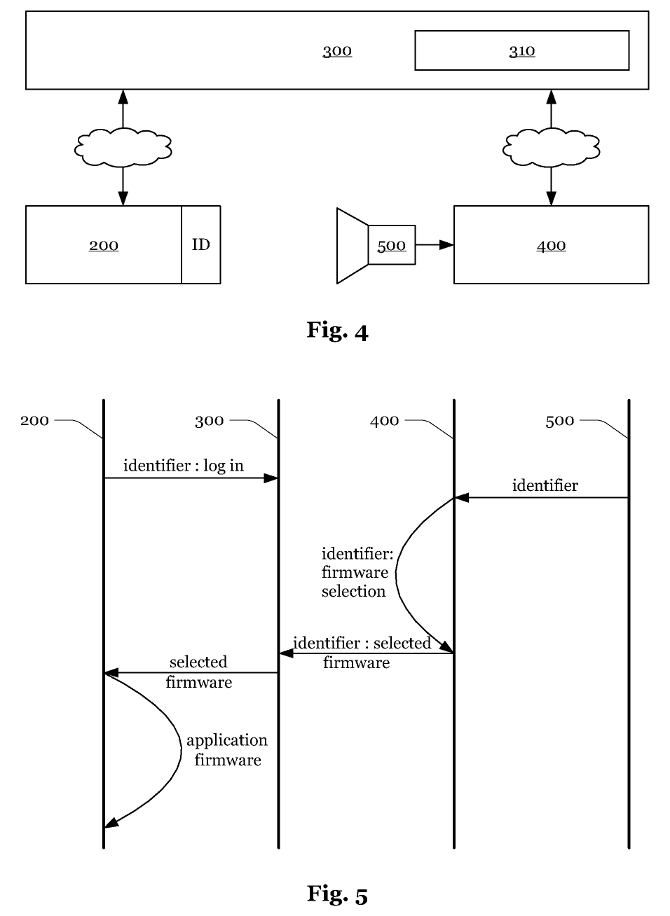

As part of defining the desired topology of the fieldbus node 100 and, if applicable, the entire automation system, operational firmware versions may be selected automatically or manually for the electronic components involved (e.g., the head station 110 or the I/O modules 120 and 130). In order to assign an operational firmware version to the unique identifier of an electronic component, the operator (e.g., a commissioning engineer) may, as illustrated in FIG. 4, detect the unique identifier of a (specific) electronic component 200 by means of an optical sensor 400 (e.g. a camera). For example, the operator (e.g., a commissioning engineer) may use a mobile phone or tablet (or another suitable computing device 400) to read a barcode or other visual representation captured by the optical sensor 500 and determine the unique identifier of the electronic component 200 from the information encoded/contained therein. For example, the fieldbus node 100 (e.g., the head station 110 or one of the I/O modules 120 and 130) may comprise several lights which sequentially output a code which represents the information. For example, the code may consist of a series of elements, each element being a 3-bit value that may be displayed by lights 102, 104, and 106.

If the unique identifiers of the electronic components 200 are already available, the operational firmware versions may be assigned to the electronic components 200 (e.g. the head station 110 or the I/O modules 120 and 130) as part of defining the desired topology of the fieldbus node 100 and, if applicable, the entire automation system. In this case, the information may include a network address (e.g., an internet address) of the server 300 and/or login and/or other authentication information with which the computing device 400 can log in to the server 300 or with which the computing device 400 can identify itself to the server 300 as authorized.

As shown in FIG. 5, the electronic component 200 may log in to the server 300 (possibly using the unique identifier) by establishing a network connection or based on input from the operator (e.g., the commissioning engineer). For example, the electronic component 200 may comprise a basic firmware version that is configured to establish a connection with the server 300 and to log in to the server 300 using the unique identifier and a password. Simultaneously to or at another time than (i.e. before or after) the one at which the electronic component 200 logs in to the server 300, the operator (e.g. the commissioning engineer) may assign an operational firmware version to the electronic component 200 on the computing device 400 (or another suitable computing device). The computing device 400 (or the other suitable computing device) may transmit the unique identifier together with information about the selected operational firmware version to the server 300, which links the unique identifier of the electronic component 200 with the selected operational firmware version in a database 310.

If the server 300 has the link and the electronic component 200 is logged in to the server 300 (or the server 300 can reach the electronic component 200), the server 300 may inform the electronic component of the operational firmware version associated with the unique identifier of the electronic component and/or transfer one or more update files associated with the operational firmware version to the electronic component. The electronic component may then install the firmware corresponding to the operational firmware version (possibly using the one or more update files).

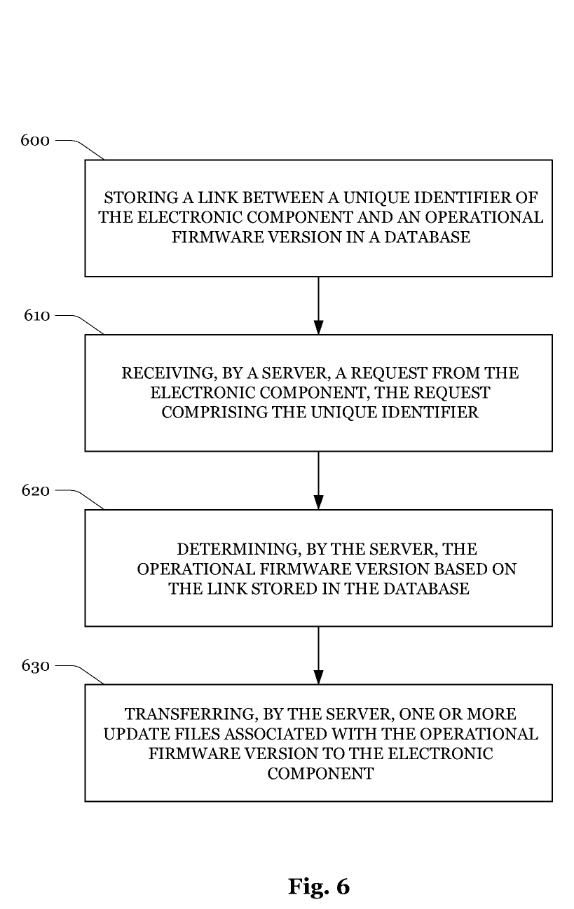

FIG. 6 shows a flowchart of a method for putting an electronic component 200 into operation. The method comprises a step 600 of storing a link between the unique identifier of the electronic component 200 and an operational firmware version in the database 310. The method further comprises a step 610 of receiving, by the server 300, a request from the electronic component 200, wherein the request comprises the unique identifier. In step 620, the server 300 determines the operational firmware version based on the link stored in the database, and in step 630, the server 300 transfers one or more update files associated with the operational firmware version to the electronic component 200. The electronic component 200 may then apply the one or more update files, thereby updating the electronic component 200 with the operational firmware version.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for putting an electronic component of a data processing system, in particular an automation system, into operation, the method comprising:
storing a link between a unique identifier of the electronic component and an operational firmware version in a database;
receiving, by a server, a request from the electronic component, the request comprising the unique identifier;
determining, by the server, the operational firmware version based on the link stored in the database; and
transferring, by the server, one or more update files associated with the operational firmware version to the electronic component.

2. The method of claim 1, further comprising transferring the unique identifier and a basic firmware version to the electronic component.

3. The method of claim 2, wherein the basic firmware version has a smaller range of functions than the operational firmware version and is essentially limited to establishing a connection to the server and installing the one or more update files.

4. The method of claim 2, wherein the one or more update files associated with the operational firmware version comprise one or more software modules, the addition of which transforms the basic firmware version into the operational firmware version.

5. A server comprising:
a processor, memory, and inputs and outputs, the server being configured to:
receive a request from an electronic component of a data processing system or an automation system, which comprises a unique identifier of the electronic component;
read an operational firmware version linked to the unique identifier of the electronic component from a database; and
communicate the operational firmware version associated with the unique identifier of the electronic component to the electronic component and/or to transfer one or more update files associated with the operational firmware version to the electronic component.

6. The server of claim 5, wherein the server is further configured to transmit information to the electronic component via which a computing device identifies itself to the server as authorized to link the unique identifier of the electronic component with the operational firmware version.

7. The server of claim 5, wherein the one or more update files associated with the operational firmware version comprise one or more software modules, the addition of which transforms the basic firmware version into the operational firmware version.

8. An electronic component of a data processing system or an automation system, the electronic component, comprising:
a processor; and
a non-volatile memory;
wherein a basic firmware version is stored on the non-volatile memory, which is configured to establish a connection to a server upon putting the electrical component into operation, send a unique identifier of the electronic component to the server, and receive one or more update files from the server.

9. The electronic component of claim 8, wherein the basic firmware version has a smaller range of functions than the operational firmware version and is essentially limited to establishing a connection to the server and installing the one or more update files.

10. The electronic component of claim 9, wherein the one or more update files comprise one or more software modules, the addition of which transforms the basic firmware version into the operational firmware version.
